(19) United States
(12) Patent Application Publication
(10) Pub. No.: US 2026/0202356 A1
(43) Pub. Date: Jul. 16, 2026

(54) SAMPLE MOUNT ASSEMBLY FOR AN X-RAY IMAGING SYSTEM AND X-RAY IMAGING SYSTEM

(71) Applicant: Carl Zeiss SMT GmbH, Oberkochen (DE)

(72) Inventor: Joy ROY, Danville, CA (US)

(21) Appl. No.: 19/015,793

(22) Filed: Jan. 10, 2025

(51) Int. Cl. G01N 23/04

(52) U.S. Cl. CPC G01N 23/04; G01N 2223/1016; G01N 2223/309

(57) ABSTRACT

A sample mount assembly for an x-ray imaging system for imaging a sample, comprises: an opening; a support surface for supporting the sample, the support surface including the opening; and a holding unit for holding the sample by exerting, adjacent an edge of the opening, a holding force on the sample towards the support surface.

### INCORPORATION BY REFERENCE

This application incorporates by reference the following commonly owned applications filed on even date herewith:
U.S. Ser. No. ______ (Attorney Docket: 36066-0080001), entitled “X-Ray Source for an X-Ray Imaging System and X-Ray Imaging System”;
U.S. Ser. No. ______ (Attorney Docket: 36066-0081001), entitled “X-Ray Imaging System and Method for Operating an X-Ray Imaging System”;
U.S. Ser. No. ______ (Attorney Docket: 36066-0083001), entitled “X-Ray Source for an X-Ray Imaging System, X-Ray Imaging System and Method for Operating an X-Ray Imaging System”;
U.S. Ser. No. ______ (Attorney Docket: 36066-0084001), entitled “X-Ray Detector Assembly, X-Ray Imaging System and Method for Manufacturing an X-Ray Detector Assembly”; and
U.S. Ser. No. ______ (Attorney Docket: 36066-0085001), entitled “X-Ray Imaging System”.

### FIELD

The present disclosure relates to a sample mount assembly for an x-ray imaging system and an x-ray imaging system with such a sample mount assembly.

### BACKGROUND

X-rays are widely used in microscopy at least in part because of their short wavelengths and ability to penetrate objects. Three-dimensional (3D) x-ray imaging techniques can be useful to image internal structures of objects. Typically, based on a dataset including x-ray transmission images of a sample that are collected over a large angular range, 3D images are reconstructed. An x-ray imaging system usually comprises a rotatable sample mount to support a sample, an x-ray source configured to illuminate a region of interest of the sample, and a position-sensitive x-ray detector configured to record x-rays transmitted through the region of interest of the sample. For precise x-ray imaging of a sample, it is desirable for the sample to remain stable during the imaging process.

### SUMMARY

The present disclosure seeks to provide an improved sample mount assembly for an x-ray imaging system and an improved x-ray imaging system.

In an aspect, the disclosure provides a sample mount assembly for an x-ray imaging system for imaging a sample. The sample mount assembly comprises a sample mount. The sample mount comprises: an opening; a support surface for supporting the sample, the support surface including the opening; and a holding unit for holding the sample by exerting, adjacent an edge of the opening, a holding force on the sample towards the support surface.

Having the sample mount with the holding unit, the sample can be maintained in a stable and stationary state during x-ray imaging of the sample. For example, even though the sample mount is rotated together with the sample around a rotation axis during imaging, it can be avoided that the sample moves relative to the sample mount. By holding (e.g., chucking) the sample with the holding unit, a precision and/or resolution of the x-ray imaging system can be increased.

Furthermore, the samples analyzed with an x-ray imaging system are, for example, flat extended objects, such as wafers. However, such a sample may exhibit small deviations from a flat geometry and be, instead, warped and/or curved (e.g., curved away from the support surface of the sample mount; e.g. by a few micrometers). Such warped and/or curved samples may, for example, arise from the energy input when printing different layers (e.g., 50 to 100 layers) of semiconductor circuits onto a wafer as a sample. A warpage and/or curvature of the sample, even on a small scale, is unfavorable for the x-ray imaging process. With the proposed holding unit, a holding force acts in the direction towards the flat support surface of the sample mount and, therefore, the warped sample can be flattened. This can help improve the x-ray imaging process because the sample is supported more stable during x-ray imaging.

The opening of the sample mount is, for example, configured for inserting an emitter head (e.g., a protruding emitter head) of an x-ray source at least partially. The opening of the sample mount is, for example, configured for passing through of x-rays unimpeded.

For example, the opening of the sample mount allows unobstructed passing through of x-rays to a region of interest of the sample or from the region of interest of the sample. Further, the holding unit can be configured for exerting the holding force on the sample adjacent an edge of the opening. Because the region of interest of the sample is arranged at the opening of the sample mount, the holding unit exerting the holding force adjacent to the edge of the opening holds the sample only in a small relevant region of the sample. For example, instead of holding and/or flattening the entire sample only a small relevant region of the sample which includes the region of interest is hold in a stationary state relative to the sample mount and/or is flattened. Thus, the region of interest of the sample can be relatively easily kept stable and flat during x-ray imaging of the sample.

The sample may have, for example, a rectangular shape, squared shape and/or circular shape in its main plane of extension. Furthermore, a size of the sample in its main plane of extension may include, for example, a diameter or side length of at least 100 millimeters (mm) (e.g., at least 200 mm, at least 300 mm, at least 400 mm, at least 500 mm). In addition, the area of the sample (with respect to its main plane of extension) which is held and/or flattened by the holding unit is, for example, at least five times (e.g., at least 10 times, at least 15 times, at least 20 times) smaller than the area of the entire sample (with respect to its main plane of extension). The area of the sample (with respect to its main plane of extension) which is held and/or flattened by the holding unit has, for example, a size including a diameter or side length of at most 50 mm (e.g., at most 30 mm, at most 20 mm, at most 10 mm).

Thus, with the proposed holding unit, the sample can be held and/or flattened close (e.g., as close as possible) to the region of interest, close to a rotation axis of the sample mount, and/or close to a head of an x-ray source of the x-ray imaging system.

The x-ray imaging system is configured for imaging a region of interest of a sample. The sample is, for example, a flat extended object. The sample is, for example, a wafer. The wafer includes, for example, electronic and/or semiconductor components. Just as an example, the x-ray imaging system may be used to inspect the wafer to investigate the quality of packaging of electronic components of the wafer. For example, the quality of mechanical and electrical bonding (e.g., buried interconnections) of the electronic components may be controlled. However, the sample may also be another object than a wafer. The sample is, for example, a circuit board or a battery.

The region of interest of the sample can be located anywhere on the sample. For example, the region of interest of the sample can be located at any position of the sample with respect to a main plane of the extension of the sample. For example, the region of interest can be located close to a center of the sample (e.g., the center being a center of the sample with respect to the main plane of extension of the sample). Further, the region of interest can be located close to an edge of the sample (e.g., the edge being an edge of the sample with respect to the main plane of extension of the sample) and/or anywhere between the center and the edge.

The x-ray imaging system is, for example, a transmission x-ray imaging system, wherein the x-rays impacting on the region of interest of the sample are partly transmitting the region of interest and are partly absorbed by the region of interest. The position-dependent transmitted portion of the x-rays can be detected by the detector (e.g., a position-sensitive x-ray detector) as a two-dimensional x-ray image.

The x-ray imaging system is, for example, a three-dimensional imaging system. The x-ray imaging system is, for example, configured to obtain two-dimensional transmission images of the region of interest for different rotation angles of the sample. Based on the two-dimensional transmission images, a three-dimensional image of the region of interest is reconstructed to reveal interior structures of the region of interest. The x-ray imaging system comprises, for example, a control device for reconstructing the three-dimensional images. The x-ray imaging system is, for example, an x-ray three-dimensional imaging system obtaining three-dimensional images by x-ray laminography and/or x-ray tomography.

The sample mount assembly is, for example, configured for supporting the sample rotatably around a rotation axis. The sample mount assembly comprises, for example, a base, wherein the sample mount is supported by the base rotatably around the rotation axis (i.e. rotatably relative to the base). The sample mount assembly further comprises, for example, a rotation drive for rotating the sample mount. The x-ray imaging system is, for example, configured for obtaining two-dimensional transmission images of the region of interest of the sample for different rotation angles of the sample with respect to the rotation axis. The rotation angles span, for example, a large angular range of 180° or more (e.g., 270° or more, 360°). Furthermore, the x-ray imaging system is, for example, configured for reconstructing a three-dimensional image of the region of interest based on the two-dimensional transmission images.

The opening of the sample mount is, for example, configured for inserting an emitter head (e.g., protruding emitter head) of the x-ray source at least partially into the opening. The emitter head of the x-ray source is, for example, inserted into the opening of the sample mount such that the x-ray source exit plane is arranged at the top/exit surface of the opening of the sample mount. Further, the x-ray source exit plane is, for example, arranged (e.g., almost) co-planar with the top/exit surface of the opening of the sample mount.

The opening of the sample mount is, for example, configured for allowing x-rays to pass through to the sample unimpeded.

The opening is, for example, a through opening, a passage opening, and/or a passageway opening.

The opening is, for example, a circular opening. However, the opening may also have another geometric shape (e.g., oval, rectangular, squared, polygonal, hexagonal etc.). Furthermore, a size (e.g., a side length or diameter) of the opening has, can be at least one centimeter (cm) (e.g., at most 2 cm, at least 3 cm, at least 5 cm).

The sample is, for example, arranged on the sample mount such that the region of interest of the sample is arranged at the opening of the sample mount. The sample is, for example, arranged on the sample mount such that the rotation axis of the sample mount passes through the region of interest of the sample.

Having the opening of the sample mount, a beam path of an x-ray beam emitted from an x-ray source of the x-ray imaging system, transmitted through the region of interest of the sample and detected by a detector of the x-ray imaging system can be free of, i.e. unobscured by, the sample mount (e.g., by material of the sample mount). Thus, a distortion (e.g., attenuation) of the x-ray beam by material of the sample mount can be avoided. Thus, x-ray imaging of the region of interest of the sample can be improved. For example, an accuracy and/or signal-to-noise ratio of the x-ray imaging can be increased.

The opening is, for example, configured for passing through of x-rays emitted by the x-ray source and/or of x-rays transmitted through the region of interest of the sample. In other words, the x-ray imaging system is configured in a first alternative such that an x-ray beam emitted from the x-ray source passes through the opening of the sample mount before irradiating the region of interest of the sample. In a second alternative, the x-ray imaging system is configured such that an x-ray beam emitted from the x-ray source and already transmitted through the region of interest of the sample passes through the opening of the sample mount.

The edge of the opening defines the opening. The edge of the opening surrounds, encloses and/or borders the opening.

The support surface of the sample mount is, in general, a flat surface (e.g., flat on a micrometer and/or nanometer scale). The support surface can define an object plane of the x-ray imaging system.

The holding unit can be configured for reducing a motion of the sample relative to the sample mount. For example, with the holding unit a motion in a direction perpendicular to the support surface and/or parallel to the support surface can be avoided.

The holding force exerted by the holding unit on the sample is, for example, a force acting in a direction towards the support surface, i.e. a direction perpendicular to the support surface.

Further, the holding unit can exert the holding force on the sample adjacent the edge of the opening. The edge of the opening is, for example, an inner edge of the sample mount. Further, the holding unit can exert the holding force, for example, in an edge region of the inner edge of the sample mount, the edge region being arranged adjacent the edge of the opening. The edge region includes, for example, the edge of the opening or does not include the edge of the opening. The edge region is, for example, an annulus surrounding the edge of the opening. Furthermore, the holding unit is, for example, arranged such that it does not obstruct the region of interest of the sample (e.g., without protruding into the opening of the sample).

The holding unit is, for example, part of the sample mount and rotates together with the sample mount.

According to some embodiments, the sample mount assembly comprises a base. The sample mount can be supported by the base rotatably around a rotation axis, and the rotation axis passes through the opening of the sample mount.

The rotation axis of the sample mount can coincide with a central axis of the opening of the sample mount.

The holding unit can be configured for exerting the holding force adjacent the opening allows to exert the holding force on the sample as close as possible to the rotation axis.

In some embodiments, the sample mount arrangement is configured such that a tilt of the actual rotation axis of the sample mount relative to an ideal rotation axis is maintained at an angle of at most five microradian (μrad) (e.g., at most 4 μrad, at most 3 μrad). For example, the base comprises a bearing for supporting the sample mount rotatably around the rotation axis. The bearing can be a high-precision bearing configured for keeping a tilt of the actual rotation axis of the sample mount relative to an ideal rotation axis at at most 5 μrad (e.g., at most 4 μrad, at most 3 μrad).

By keeping a wobble of the rotation axis of the sample mount (e.g., a cyclic tilting of the support surface of the sample mount) relatively small, also the sample supported on the sample mount can have a relatively small angular wobble with respect to the rotation axis. Therefore, Abbe errors (sine errors, i.e. a magnification of an angular error over distance) can be kept relatively small.

According to some embodiments, the holding unit comprises multiple holding elements. Each holding element can be configured for exerting a holding force on the sample, and the sample mount assembly can be configured for controlling the multiple holding elements such that one or more selected ones of the multiple holding elements exert a holding force on the sample and the other ones of the multiple holding elements are idle.

Selected holding elements can be used for exerting a holding force on the sample, while the other holding elements are idle (i.e. do not exert a holding force). This configuration can be desirable in a case in which the sample is arranged on the sample mount such that only a subset of the multiple holding elements is covered by the sample, while the remaining subset of the multiple holding elements is not covered by the sample.

The multiple holding elements are, for example, arranged spaced apart from each other. The multiple holding elements are, for example, arranged along an annulus arranged adjacent the edge of the opening. The annulus is, for example, arranged surrounding the opening of the sample mount. The annulus is, for example, arranged concentrically to the rotation axis of the sample mount. The annulus is, for example, a circular annulus (e.g., in the case of a circular opening of the sample mount). The annulus may also be, for example, an oval, rectangular, squared and/or polygonal annulus (e.g., in the case of a respective oval, rectangular, squared and/or polygonal opening of the sample mount).

According to some embodiments, the holding unit comprises at least one suction element for exerting a suction force on the sample.

By using a suction force, the sample can be held without mechanically gripping and/or clamping the sample. Hence, the sample can be held in a gentle manner and without damaging the sample. Gentle holding of the sample can be desirable because the holding force is applied close to the region of interest and not at an outer edge of the sample (e.g., a handling edge where there are, for example, no sensible structures of the sample).

The at least one suction element is, for example, arranged at the support surface. The at least one suction element is, for example, configured for exerting an attractive force on the sample.

The at least one suction element is, for example, at least one vacuum chuck.

According to some embodiments, the at least one suction element comprises: at least one recess recessed from the support surface; and at least one suction line fluidly connected to the at least one recess for generating a negative pressure inside the at least one recess.

The at least one recess is, for example, a recess that is set back against a plane of the support surface.

The sample mount assembly comprises, for example, at least one vacuum pump for providing the negative pressure (e.g., a vacuum) inside the at least one recess (e.g., for sucking off air through the at least one suction line from the at least one recess).

According to some embodiments, the at least one suction element comprises multiple spaced apart suction elements arranged along an annulus adjacent the edge of the opening.

The multiple suction elements include, for example, three suction elements for a three-point suction. However, the multiple suction elements may also include another number of suction elements.

The multiple suction elements are, for example, arranged along an annulus which is arranged surrounding the opening of the sample mount. The multiple suction elements are, for example, arranged along an annulus which is arranged concentrically to the rotation axis of the sample mount.

The annulus is, for example, a circular annulus (e.g., in the case of a circular opening of the sample mount). The annulus may also be, for example, an oval, rectangular, squared and/or polygonal annulus (e.g., in the case of a respective oval, rectangular, squared and/or polygonal opening of the sample mount).

According to some embodiments, the multiple suction elements are evenly distributed along the annulus.

Thus, the suction force can be applied evenly distributed around the opening of the sample mount. Hence, the suction force can be applied evenly distributed around the region of interest of the sample.

According to some embodiments, the at least one suction element comprises a ring-shaped suction element arranged adjacent the edge of the opening.

The ring-shaped suction element is, for example, arranged surrounding the opening of the sample mount. The ring-shaped suction element is, for example, arranged concentrically to the rotation axis of the sample mount.

The ring-shaped suction element comprises, for example, a ring-shaped recess recessed from the support surface. Further, the ring-shaped recess is, for example, fluidly connected to at least one suction line.

According to some embodiments, the ring-shaped suction element comprises multiple ring segments, and the sample mount assembly is configured for controlling the multiple ring segments such that one or more selected ones of the ring segments exert a suction force on the sample and the other ring segments are idle.

Selected ring segments can be put under negative pressure and, hence, used for exerting a suction force on the sample, while the other ring segments are idle (i.e. do not exert a suction force). This configuration can be desirable when the sample is arranged on the sample mount such that only a portion of the ring-shaped suction element (and hence only a subset of its ring segments) is covered by the sample, while the remaining portion of the ring-shaped suction element (and hence the remaining subset of the ring segments) is not covered by the sample.

The ring-shaped suction element comprises, for example, multiple dividing bars dividing the multiple ring segments from each other in a gas tight and/or vacuum tight manner.

Each ring segment may, for example, be fluidly connected to a respective suction line for generating a negative pressure in the respective ring segment, wherein a suction power of each suction line can be controlled independently.

Alternatively, the multiple dividing bars are configured movable and/or have an opening mechanism such that selected ring segments can be fluidly connected with each other by moving and/or opening the respective dividing bars. The selected fluidly joined ring segments can be put under negative pressure together (e.g., by using a single suction line).

In some embodiments, the at least one suction element comprises a non-circular shaped suction element arranged adjacent the edge of the opening.

In some embodiments, the holding unit comprises at least one electrostatic element for exerting an electrostatic force on the sample.

According to some embodiments, the holding unit comprises at least one compressed air nozzle arranged facing the support surface for exerting a pressing force on the sample.

By using a pressing force, the sample can be pressed towards the support surface. For example, by using a pressing force, the sample can be hold on the sample mount contact-free.

According to some embodiments, the sample mount comprises a further holding unit for holding the sample by exerting a further holding force on an outer edge of the sample towards the support surface.

In addition to holding the sample close to the opening of the sample mount and, hence, close to the region of interest of the sample, the sample can be held by the further holding unit at the outer edge thereof (e.g., at a handling edge of the sample). Therefore, the sample can be stabilized even more.

The further holding force includes, for example, a mechanical force (e.g. a gripping force and/or clamping force), a suction force (e.g., exerted by one or more of the above-described suction elements) and/or a pressive force (e.g., exerted by one or more of the above-described compressed air nozzles). A mechanical force is, for example, exerted by a C-shaped bracket or another suitable mechanical holder.

According to an aspect, an x-ray imaging system for imaging a sample is provided. The x-ray imaging system comprises an above-described sample mount assembly.

According to embodiments, an x-ray imaging system further comprises: an x-ray source for emitting x-rays towards a region of interest of the sample; and an x-ray detector for detecting x-rays transmitted through the region of interest.

The x-ray source comprises, for example, a vacuum chamber. The x-ray source comprises, for example, a pump for evacuating the vacuum chamber. The x-ray source comprises, for example, an electron source accommodated in the vacuum chamber. The electron source can be configured for emitting an electron beam towards an x-ray target of the x-ray source. The electron source includes, for example, a cathode and an anode and the like for generating electrons and for accelerating the generated electrons.

The x-ray source comprises, for example, one or more electron optics units for directing, deflecting and/or shaping the electron beam emitted from the electron source. The electron optics include, for example, one or more magnetic lenses for focusing the electron beam and/or one or more deflection units for deflecting the electron beam.

The x-ray source comprises, for example, an x-ray target. The x-ray target can be configured for emitting x-rays when bombarded with the focused electron beam. A material of the at least one x-ray target comprises, for example, one or more of a group including tungsten (W), copper (Cu), chromium (Cr), molybdenum (Mo), rhodium (Rh) and platinum (Pt). The x-rays generated by the at least one x-ray target can include, for example, characteristic lines determined by the target's composition and broad bremsstrahlung radiation.

The x-ray source includes, for example, a carrier element carrying the x-ray target (or carrying multiple of the x-ray targets which can be selected by directing the electron beam accordingly). The carrier element is, for example, x-ray transmissive. The carrier element forms, for example, a vacuum window of the vacuum chamber. Alternatively, an additional vacuum window may be provided. A material of the carrier element and/or the vacuum window includes, for example, atomic elements having atomic numbers less than 14. The material of the carrier element and/or the vacuum window includes, for example, one or more of a group including beryllium (Be), diamond, boron carbide (B₄C), silicon carbide (SiC), aluminum (Al), and beryllium oxide (BeO). The material of the carrier element and/or the vacuum window can be diamond.

The carrier element and/or the vacuum window being x-ray transmissive means, for example, that it has an x-ray transmission such that more than 50% of the x-rays generated by the at least one x-ray target having energies greater than one-half of the selected maximum focused electron energy are transmitted through the carrier element.

The carrier element has, for example, a sufficiently high thermal conductivity to provide a thermal conduit to prevent thermal damage (e.g., melting) of the x-ray target. Further, the carrier element can, for example, also provide an electrically conductive path to dissipate electric charge from the at least one x-ray target and/or the carrier element itself.

The x-ray source is, for example, a transmission target type x-ray source. The electron beam can strike the at least one x-ray target of the x-ray source at its backside and the at least one x-ray target can emit x-rays at its front side, wherein the emitted x-rays can be used to irradiate the sample.

The x-ray source can generate diverging x-rays, i. e. a cone (conus) of x-rays. A portion (i.e. a sub cone) of the generated diverging x-rays can irradiate the region of interest of the sample. A center line of this sub cone of x-rays is referred to as x-ray propagation axis. This means that the x-ray propagation axis indicates the direction of an x-ray beam which is a portion of the total generated diverging x-rays of the x-ray source.

The x-ray detector is, for example, a position-sensitive x-ray detector. The x-ray detector is, for example, configured for converting incoming x-rays into light of longer wavelength, e.g., ultraviolet light, visible light or infrared light. The x-ray detector includes, for example, a scintillator material at a transfer field of the detector for converting the x-rays into detectable light and a detector array (e.g., a CCD or CMOS array) for detecting the detectable light.

According to some embodiments, the x-ray imaging system comprises a relocation unit for relocating the sample relative to the sample mount, wherein the relocation unit is configured for arranging the sample on the sample mount such that the region of interest of the sample is arranged at the opening of the sample mount.

Having the relocation unit means that the sample can be easily arranged (e.g. placed) on the sample mount and/or relocated relative to the sample mount. Having the relocation unit means that the sample can be arranged on the sample mount with its region of interest placed on the opening. For example, any region of the sample can be defined as a region of interest and can be arranged at the opening of the sample mount.

The relocation unit includes, for example, a robotic unit. The relocation unit comprises, for example, one or more tools and/or end effectors for taking up (e.g., lifting up) the sample. The relocation unit comprises, for example, two or more forks for taking up the sample. The relocation unit includes, for example, a forklift. However, the relocation unit may also have another configuration suitable for moving the sample in a translational manner and/or rotational manner.

That the region of interest of the sample is arranged at the opening of the sample mount, includes, for example, that the region of interest is not covered by the sample mount. In other words, the (e.g., entire) region of interest is exhibited at the sample mount through the opening. The region of interest is, for example, exhibited at the sample mount as seen from a backside of the sample mount. Herein, a support side of the sample mount supporting the sample is called a frontside of the sample mount and the backside of sample mount is arranged opposite the support side.

The relocation unit is, for example, configured for translating and/or rotating the sample relative to the sample mount. The relocation unit is, for example, configured for translating the sample relative to the sample mount in three translational degrees of freedom (x, y, z), the three translational degrees of freedom spanning up a three-dimensional space (e.g., three directions in space which are arranged perpendicular to each other). The relocation unit is, for example, configured for rotating the sample relative to the sample mount in at least one rotational degree of freedom, e.g., a rotation (Rz) around a direction arranged parallel to the rotation axis of the sample mount. The relocation unit may also be configured for rotating the sample relative to the sample mount in three rotational degrees of freedom (Rx, Ry, Rz) corresponding to a rotation around the three directions of the translational degrees of freedom (x, y, z).

In some embodiments, the support surface of the sample mount is configured for supporting the sample such that an outer portion of the sample is protruding from the support surface. In this case, the outer protruding portion of the sample—which is not laying on the support surface—can be mechanically contacted (e.g., taken up and/or lifted) by the relocation unit (e.g., by tools and/or end effectors of the relocation unit) to relocate the sample.

According to some embodiments, the x-ray imaging system is configured for obtaining two-dimensional transmission images of the region of interest of the sample for different rotation angles of the sample with respect to the rotation axis, and for reconstructing a three-dimensional image of the region of interest based on the two-dimensional transmission images.

Further possible implementations or alternative solutions of the disclosure also encompass combinations—that are not explicitly mentioned herein—of features described above or below with regard to the embodiments. The person skilled in the art may also add individual or isolated aspects and features to the most basic form of the disclosure.

### BRIEF DESCRIPTION OF THE DRAWINGS

Further embodiments, features and aspects of the present disclosure will become apparent from the subsequent description and dependent claims, taken in conjunction with the accompanying drawings, in which:

FIG. 1 shows a schematic cross-section view of an x-ray imaging system for imaging a sample according to an embodiment;

FIG. 2 shows a schematic cross-section view of a sample mount assembly of the x-ray imaging system of FIG. 1 according to an embodiment;

FIG. 3 shows a schematic cross-section view of a sample mount assembly of the x-ray imaging system of FIG. 1 according to a further embodiment;

FIG. 4 shows a schematic perspective view of a sample mount assembly of the x-ray imaging system of FIG. 1 according to a further embodiment;

FIG. 5 shows a view similar as FIG. 4, wherein a sample is arranged on the sample mount;

FIG. 6 shows a view similar as FIG. 5 but with the sample being relocated relative to the sample mount;

FIG. 7 shows a schematic perspective view of a sample mount assembly of the x-ray imaging system of FIG. 1 according to a further embodiment;

FIG. 8 shows a variant of the sample mount assembly of FIG. 7 according to an embodiment;

FIG. 9 shows a schematic perspective view of a sample mount assembly of the x-ray imaging system of FIG. 1 according to a further embodiment; and

FIG. 10 shows a schematic cross-section view of a sample mount assembly of the x-ray imaging system of FIG. 1 according to a further embodiment.

In the Figures, like reference numerals designate like or functionally equivalent elements, unless otherwise indicated.

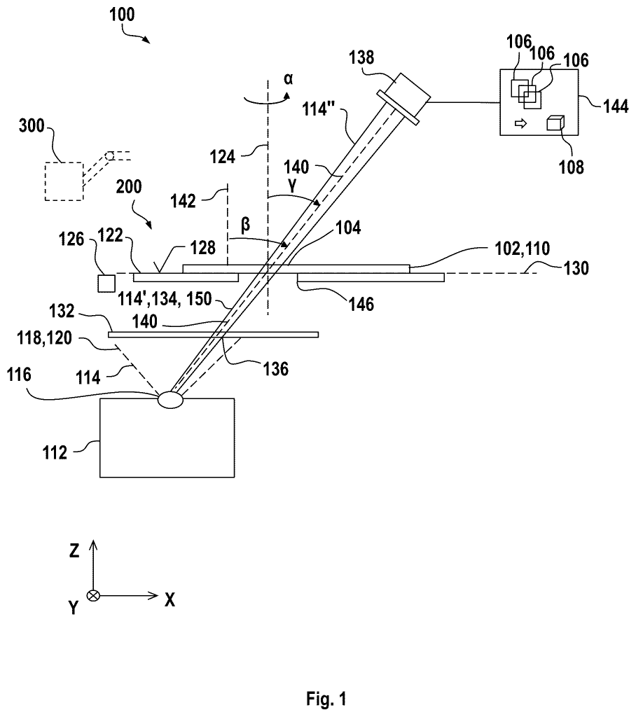

FIG. 1 shows a schematic view of an x-ray imaging system 100 according to an embodiment. The x-ray imaging system 100 is used for imaging a sample 102, for example a region of interest 104 of the sample 102. The x-ray imaging system 100 is configured to obtain two-dimensional transmission images 106 of the region of interest 104 for different rotation angles α of the sample 102. Based on the two-dimensional transmission images 106, a three-dimensional (3D) image 108 of the region of interest 104 is reconstructed to reveal interior structures of the region of interest 104. The x-ray imaging system 100 is, hence, an x-ray 3D imaging system obtaining 3D images 108 by x-ray laminography and/or x-ray tomography.

The sample 102 is, for example, a flat object extended in a main plane (e.g., the xy-plane in FIG. 1). The sample 102 is, for example, a wafer 110 comprising electronic and/or semiconductor components. Just as an example, the x-ray imaging system 100 may be used to inspect the wafer 110 to investigate the quality of packaging of electronic components of the wafer 110. For example, the quality of mechanical and electrical bonding (e.g., buried interconnections) of the electronic components may be controlled.

The x-ray imaging system 100 comprises an x-ray source 112 for emitting x-rays 114. The x-rays 114 are emitted from a source region 116 of the x-ray source 112. The x-ray source 112 emits a diverging beam 118 of x-rays 114. In other words, the x-ray source 112 emits a cone 120 of x-rays 114. The sample 102 is arranged within the x-ray emission cone 120.

The x-ray imaging system 100 further comprises a sample mount 122 for supporting the sample 102 rotatably around a rotation axis 124. The rotation axis 124 passes, for example, through the region of interest 104 of the sample 102. For example, the rotation axis 124 can be arranged off-center with respect to a center of the sample 102. A rotation drive 126 for rotating the sample mount 122 and, hence, the sample 102, is shown schematically in FIG. 1. Furthermore, the sample mount 122 has a support surface 128 for supporting the sample 102, wherein the support surface 128 defines an object plane 130 of the x-ray imaging system 100.

The x-ray imaging system 100 may optionally comprise, for example, a shield stop 132 arranged between the x-ray source 112 and the sample mount 122. The shield stop 132 is, for example, arranged in a light path of the x-rays 114 emitted from the x-ray source 112. The shield stop 132 serves to select a usable portion 134 (sub cone 134) of the x-ray cone 120. Moreover, the shield stop 132 protects uninspected regions of the sample 102 from x-ray exposure. The shield stop 132 has an aperture 136 through which the usable portion 134 of the x-ray light 114 (114′) propagates in the direction of the region of interest 104 of the sample 102 and transmits the region of interest 104 of the sample 102.

The x-ray imaging system 100 further comprises a position-sensitive x-ray detector 138 for detecting x-rays 114″ transmitted through the region of interest 104 of the sample 102. The position-sensitive x-ray detector 138 is, for example, configured to convert the incoming x-rays 114″ into light of longer wavelength, e.g., UV-light, visible light or infrared light. The x-ray detector 138 includes, for example, a scintillator material at a transfer field of the detector 138 for converting the x-rays 114″ into detectable light and a detector array 138 (e.g., a CCD or CMOS array) for detecting the detectable light.

FIG. 1 displays an x-ray propagation axis 140 of the x-ray imaging system 100. For example, a central axis of the portion 134 (sub light cone 134) of the x-ray light 114 passing through the shield stop 132 defines the x-ray propagation axis 140. The x-ray propagation axis 140 extends from the x-ray source 112 (i.e., the source region 116 of the x-ray source 112), through the region of interest 104 of the sample 102, and to the position-sensitive x-ray detector 138.

As can be seen in FIG. 1, the x-ray propagation axis 140 of the x-ray imaging system 100 is, for example, inclined with respect to a surface normal 142 of the sample mount 122 by a first angle β. In addition, the x-ray propagation axis 140 is, for example, inclined with respect to the rotation axis 124 by a second angle γ. In the example of FIG. 1, the surface normal 142 of the sample mount 122 and the rotation axis 124 are arranged parallel to each other and, hence, the first angle β and the second angle γ have the same size.

The x-ray exposures 106 obtained at different rotation angles α of the sample 102 are reconstructed to a 3D image 108 by a control system 144 of the imaging system 100.

The x-ray imaging system 100 provides microscopic imaging. A magnification and, hence, a spatial resolution, of the x-ray imaging system 100 depends on the size of the source region 116 of the x-ray source 112.

Moreover, an imaging time to obtain a 3D image 108 of the region of interest 104 of the sample 102 depends on the x-ray flux density at the region of interest 104. The imaging time (exposure time) limits, for example, a throughput rate when imaging multiple samples 102 with the x-ray imaging system 100. The smaller the distance between the x-ray source 112 and the sample 102, the higher is the x-ray flux density at the region of interest 104 of the sample 102. For example, the x-ray flux incident on the region of interest 104 is inversely proportional to the square of the distance of the region of interest 104 from the x-ray source 112 (for example, from an x-ray target of the x-ray source 112).

As shown in FIG. 1, the sample mount 122 has an opening 146 for passing through of the x-rays 114′ emitted from the x-ray source 112 to the sample 102.

With the opening 146 of the sample mount 122, it can be prevented that the x-ray beam 134 traveling from the x-ray source 112 to the region of interest 104 of the sample 102 and further to the x-ray detector 138 transmits the sample mount 122. In other words, a beam path 150 of the x-ray beam 134 emitted from the x-ray source 112, transmitted through the region of interest 104 and detected by the detector 138 is free of (i.e. unobstructed by) the sample mount 122. Hence, a distortion of the x-ray beam 134 by material of the sample mount 122 can be avoided.

In the examples shown in the figures, the x-ray imaging system 100 is configured such that the x-ray beam 134 emitted from the x-ray source 112 passes through the opening 146 of the sample mount 122 before irradiating the region of interest 104 of the sample 102. However, although not shown in the figures, an x-ray imaging system may also be configured such that—in the orientation of FIG. 1—an x-ray source 112 is arranged above the sample 102 and the sample mount 122, and an x-ray detector 138 is arranged below the sample 102 and the sample mount 122. In this case, the opening 146 of the sample mount 122 would be configured for passing through of the x-rays 114″ transmitted through the region of interest 104 and traveling to the detector 138. In other words, in this case, an x-ray beam already transmitted through the region of interest 104 of the sample 102 passes through the opening 146 of the sample mount 122 before reaching the detector 138.

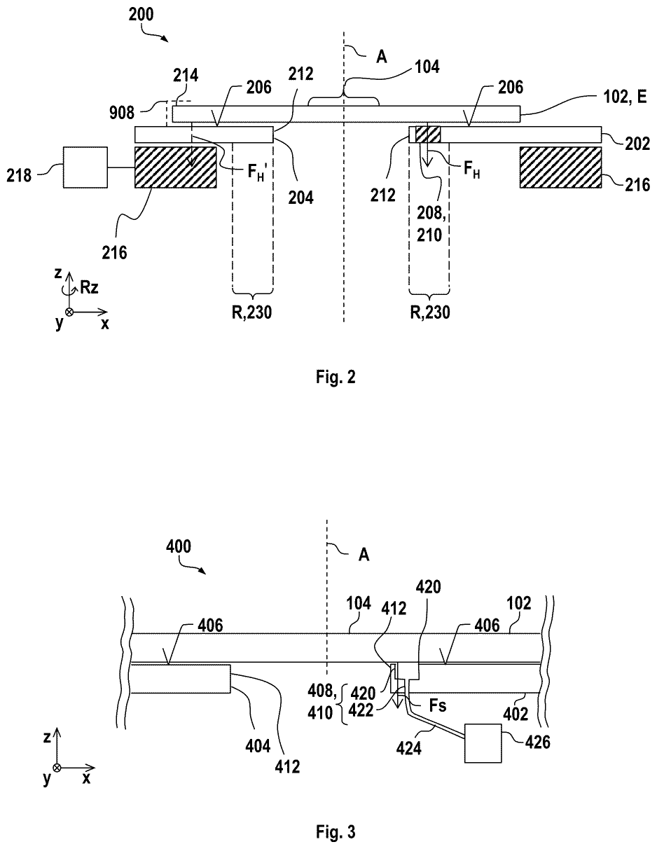

FIG. 2 shows a detailed view of a sample mount arrangement 200 of the x-ray imaging system 100 of FIG. 1. The sample mount arrangement 200 comprises a sample mount 202 (similar as the sample mount 122 in FIG. 1). The sample mount 202 includes an opening 204 for passing through of x-rays 114′ (similar as the opening 146 in FIG. 1). The sample mount 202 further includes a support surface 206 for supporting a sample 102 (similar as the support surface 128 in FIG. 1). The support surface 206 is a flat support surface arranged in a xy-plane in FIG. 2. Also a main plane E of extension of the sample 102 is arranged in the xy-plane in FIG. 2. The support surface 206 of the sample mount 202 includes the opening 204.

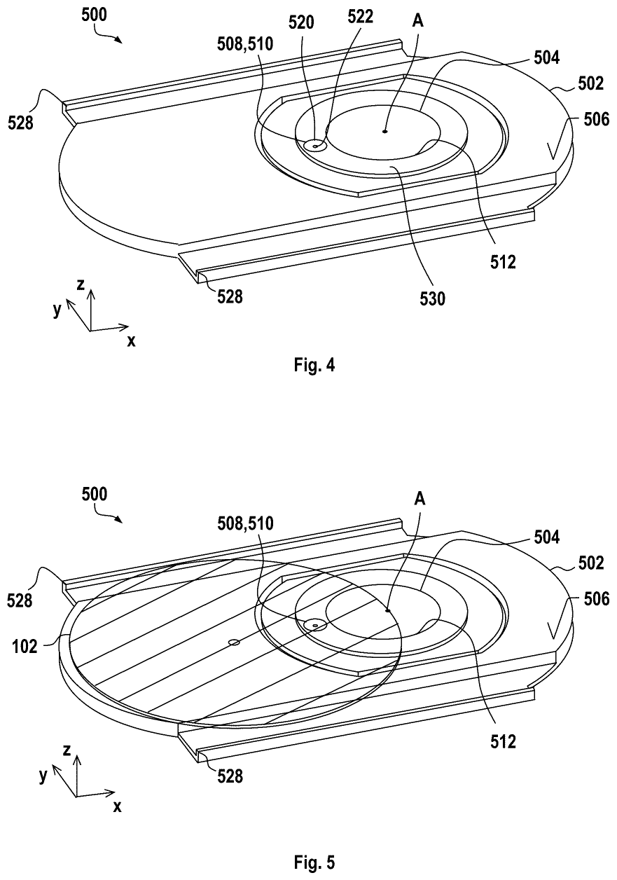

The opening 204 of the sample mount 202 is a through-opening. The opening 204 has, in the xy-plane in FIG. 2, for example, a circular shape (see for example FIG. 4). However, the opening 204 may also have another geometric shape in the xy-plane different from a circular shape.

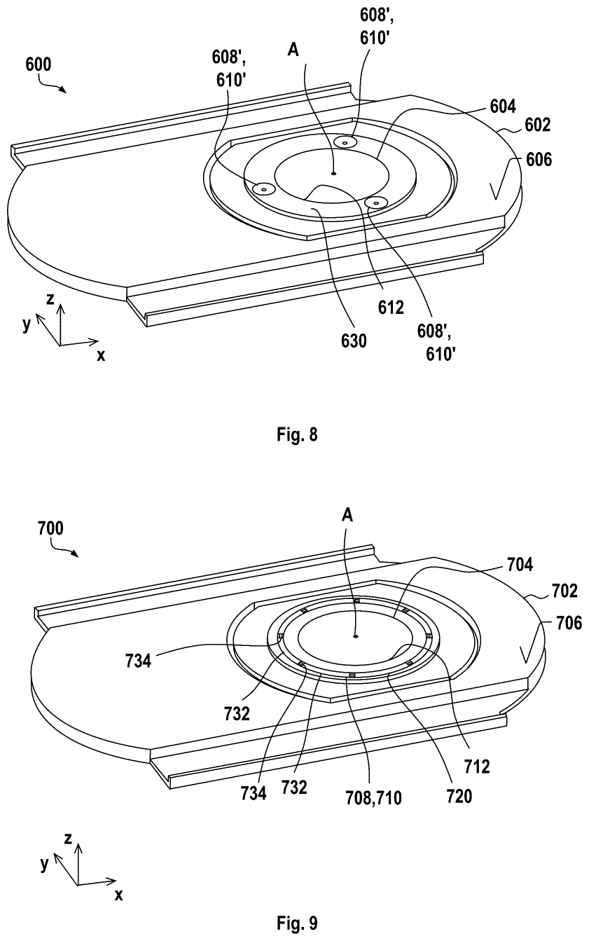

The sample mount 202 further comprises a holding unit 208 for holding the sample 102 at the sample mount 202. The holding unit 208 is, for example, configured for exerting a holding force F_{H} on the sample 102. In the example of FIG. 2, the holding unit 208 comprises one holding element 210. However, the holding unit 208 may also comprise more than one holding unit 210 (e.g., FIGS. 7, 8). The holding force F_{H} exerted by the holding unit 208 is directed towards the support surface 206 such that the sample 102 is attracted and/or pressed towards the support surface 206. Thereby, the sample 102 can be hold stationary with respect to the sample mount 202 and can be flattened.

For example, a sample 102 under investigation with the x-ray imaging system 100 may exhibit small deviations (e.g. of the order of a few micrometers) from a flat geometry and be, instead, warped and/or curved (e.g., curved away from the support surface 206 of the sample mount 202). Having the holding unit 208, such a warpage (not shown in the figures) of the sample 102 can be compensated at least partially by exerting the holding force F_{H} on the sample 102 (e.g., at multiple locations of the sample 102) in the direction towards the support surface 206.

The holding force F_{H} is exerted by the holding unit 208 adjacent an edge 212 of the opening 204. The edge 212 of the opening 204 is, for example, an inner edge of the sample mount 202. Hence, the sample 102 is held and/or flattened close to its region of interest 104—instead of or in addition to holding the sample 102 at an outer edge 214 of the sample 102.

That the holding force FH is exerted adjacent the edge 212 of the opening 204 includes, for example, that the holding force F_{H} is exerted in an edge region R of the sample mount 202. The edge region R is arranged adjacent to the edge 212 of the opening 204 and may include the edge 212 itself or may not include the edge 212. The edge region R includes, for example, an annulus 230 (see also 530, 630 in FIGS. 4, 7) surrounding the edge 212 of the opening 204.

Furthermore, the holding unit 208 is, for example, arranged such that it does not obstruct the region of interest 104 of the sample 102. (e.g., without protruding into the opening 204 of the sample mount 202).

The sample mount 202 is, for example, configured for rotating together with the sample 102 around a rotation axis A (similar as the rotation axis 124 in FIG. 1). The sample mount assembly 200 comprises, for example, a base 216 and a rotation drive 218. Further, the sample mount 202 is supported by the base 216 rotatably around the rotation axis A (e.g., by a bearing, not shown) and is driven by the rotation drive 218 to rotate relative to the base 216. The rotation axis A of the sample mount 202 passes, for example, through the opening 204 of the sample mount 202.

As can be seen in FIG. 2, the sample 102 is arranged on the support surface 206 of the sample mount 202 such that a region of interest 104 of the sample 102 is arranged at the opening 204. Further, the region of interest 104 is arranged at the rotation axis A. As illustrated in FIG. 1, the x-ray imaging system 100 may comprise a relocation unit 300 (e.g., a robotic unit) for relocating the sample 102 relative to the sample mount 122, 202. With the relocation unit 300, the sample 102 can be easily arranged on the sample mount 122, 202 such that the region of interest 104 of the sample 102 is arranged at the opening 146, 204 of the sample mount 122, 202. The relocation unit 300 is, for example, configured for translating (e.g., in x, y-, z-direction) and/or rotating (e.g., in Rz direction) the sample 102 relative to the sample mount 122, 202.

FIG. 3 shows a partial view of a sample mount assembly 400 according to a further embodiment. In the following, mainly only difference to the sample mount assembly 200 of FIG. 2 are described. Shown in FIG. 3 is a sample mount 402 with a support surface 406 for supporting a sample 102. Similar as in FIG. 2, the sample mount 402 comprises an opening 404 (e.g., circular opening) for passing through of x-rays 114′. The opening 404 has an edge 412 (e.g., a circular edge).

Although not shown in FIGS. 4 to 10, also in these embodiments, a base and rotation drive—similar as the base 216 and rotation drive 218 in FIG. 2—may be provided.

In the embodiment of FIG. 3, the holding unit 408 comprises at least one suction element 410 for exerting a suction force FS on the sample 102. The at least one suction element 410 comprises, for example, at least one recess 420 recessed from the support surface 406. In addition, the at least one suction element 410 comprises, for example, at least one suction line 422 fluidly connected to the at least one recess 420. The sample mount assembly 400 may further comprise a further suction line 424 fluidly connected at one end to the suction line 422 of the suction element 410 and at another end to a vacuum pump 426 for generating a negative pressure inside the at least one recess 420.

FIG. 4 shows a perspective view of a sample mount assembly 500 according to a further embodiment. The sample mount assembly 500 comprises, similar as the sample mount assembly 400 of FIG. 3, a sample mount 502 with a support surface 506 for supporting a sample 102 and an opening 504 for passing through of x-rays 114′. Further, the sample mount 502 comprises, similar as the sample mount assembly 400 of FIG. 3, a holding unit 508 comprising at least one suction element 510 with at least one recess 520 recessed from the support surface 506 and at least one suction line 522 fluidly connected to the at least one recess 520. The at least one suction element 510 is, for example, arranged at an annulus 530 adjacent an edge 512 of the opening 504 of the sample mount 502.

The sample mount 502 further comprises optionally gripping recesses 528 configured as two grooves, the gripping recesses 528 are recessed from the support surface 506. The gripping recesses 528 can be used for gripping the sample 102 with a relocation unit 300 (FIG. 1). The relocation unit 300 comprises, for example, at least one tool (e.g., fork or the like) for inserting the at least one tool into the gripping recesses 528 of the sample mount 502.

It is noted that any sample mount 202 and 402 to 802 described herein may have one or more gripping recesses, e.g., similar as the gripping recesses 528 in FIG. 4.

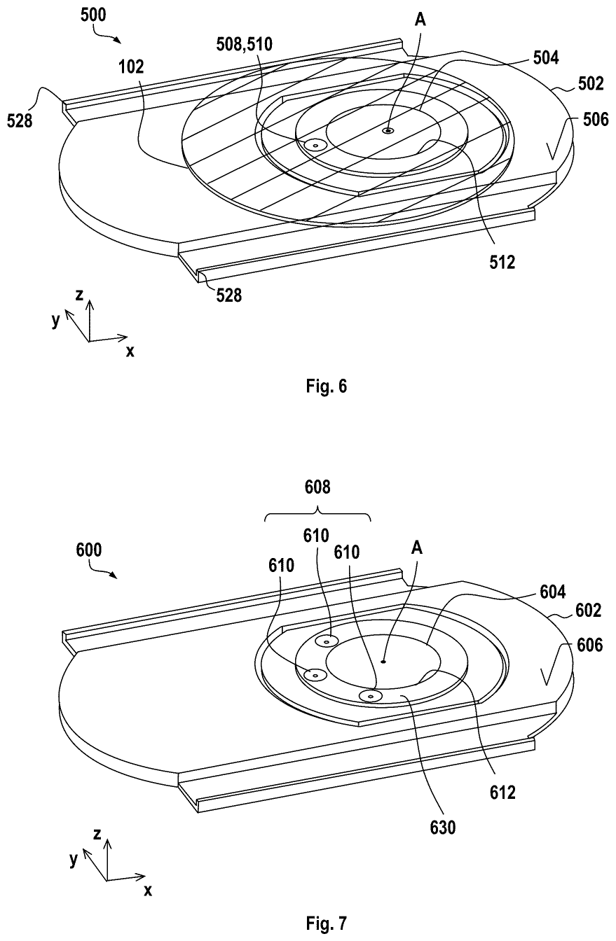

FIG. 5 shows the sample mount assembly 500 of FIG. 4 together with a sample 102 is arranged on the support surface 506 of the sample mount 502. Furthermore, FIG. 6 shows the sample mount assembly 500 of FIG. 5 with the sample 102 relocated relative to the sample mount 502. For example, in FIG. 5 the sample 102 covers the opening 504 partially. Further, in FIG. 5 the sample 102 covers the opening 504 entirely.

FIG. 7 shows a perspective view of a sample mount assembly 600 according to a further embodiment. The sample mount assembly 600 comprises, similar as the sample mount assembly 500 of FIG. 4, a sample mount 602 with a support surface 606 for supporting a sample 102 and an opening 604 for passing through of x-rays 114′. Further, the sample mount 602 comprises, similar as the sample mount assembly 500 of FIG. 4, a holding unit 608 for holding the sample 102. In the embodiment of FIG. 7, the holding unit 608 comprises multiple suction elements 610. Exemplarily, three suctions elements 610 are shown. However, also another number of suction elements 610 can be provided. The multiple suction elements 610 are arranged along an annulus 630 adjacent an edge 612 of the opening 604 of the sample mount 602. Further, the multiple suction elements 610 are arranged spaced apart from each other.

FIG. 8 shows a variant of the sample mount assembly 600 of FIG. 7. In the sample mount assembly 600′ of FIG. 7, the multiple suction elements 610′ of the holding unit 608′are evenly distributed along the annulus 630.

FIG. 9 shows a perspective view of a sample mount assembly 700 according to a further embodiment. The sample mount assembly 700 comprises, similar as the sample mount assembly 500 of FIG. 4, a sample mount 702 with a support surface 706 for supporting a sample 102 and an opening 704 for passing through of x-rays 114′. Further, the sample mount 702 comprises, similar as the sample mount assembly 500 of FIG. 4, a holding unit 708 for holding the sample 102. In the embodiment of FIG. 9, the holding unit 708 comprises a ring-shaped suction element 710 arranged adjacent the edge 712 of the opening 704.

The ring-shaped suction element 710 is, for example, arranged surrounding the opening 704 of the sample mount 702 and concentrically to the rotation axis A of the sample mount 702. The ring-shaped suction element 710 comprises, for example, a ring-shaped recess 720 recessed from the support surface 706. Further, the ring-shaped recess 720 is, for example, fluidly connected to at least one suction line (not shown in FIG. 9).

As shown in FIG. 9, the ring-shaped suction element 710 may, for example, comprise multiple ring segments 732 (two of them are denoted with a reference sign in FIG. 9). In this case, the sample mount assembly 700 may be configured for controlling a suction force F_{S} for each ring segment 732 independently. Thus, selected ring segments 732 can be put under negative pressure and, hence, used for exerting a suction force F_{S}, while the other ring segment 732 are idle. For example, the ring-shaped suction element 710 comprises multiple dividing bars 734 (two of them are denoted with a reference sign in FIG. 9). The dividing bars 734 divides the multiple ring segments 732 from each other in a gas tight and/or vacuum tight manner.

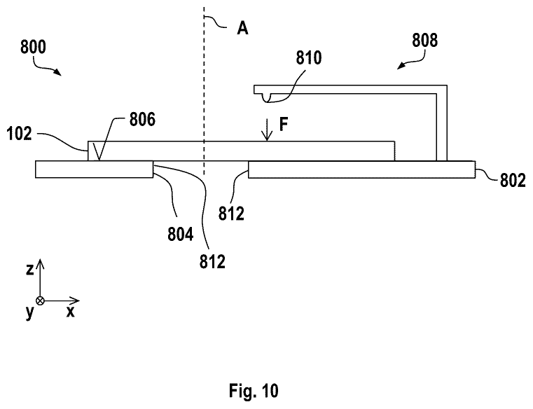

FIG. 10 shows a cross-section view of a sample mount assembly 800 according to a further embodiment. The sample mount assembly 800 comprises, similar as the sample mount assembly 400 of FIG. 3, a sample mount 802 with a support surface 806 for supporting a sample 102 and an opening 804 for passing through of x-rays 114′. Further, the sample mount 802 comprises, similar as the sample mount assembly 400 of FIG. 3, a holding unit 808 for holding the sample 102. In the embodiment of FIG. 10, the holding unit 808 comprises at least one compressed air nozzle 810 arranged facing the support surface 806. The at least one compressed air nozzle 810 is configured for exerting, adjacent the edge 812 of the opening 804, a pressing force F_{P} on the sample 102.

As illustrated exemplarily with dotted lines in FIG. 2, any sample mount assembly 200 and 400 to 800 described herein may optionally include—in addition to the described holding unit 208 and 408 to 808—a further holding unit 908. The further holding unit 908 is configured for holding the sample 102 by exerting a further holding force (F_{H}′) on an outer edge 214 of the sample 102 towards the support surface 206.

Although the present disclosure has been described in accordance with certain embodiments, it is obvious for the person skilled in the art that modifications are possible in all embodiments.

### REFERENCE NUMERALS

100 System
102 Sample
104 Region of interest
106 2D image
108 3D image
110 Wafer
112 Source
114 X-ray
114′, 114″ X-ray
116 Source region
118 Beam
120 Cone
122 Sample mount
124 Rotation axis
126 Rotation drive
128 Surface
130 Object plane
132 Shield stop
134 Sub cone
136 Aperture
138 Detector
140 Axis
142 Surface normal
144 Control system
146 Opening
200 Sample mount assembly
202 Sample mount
204 Opening
206 Support surface
208 Holding unit
210 Holding element
212 Edge
214 Edge
216 Base
218 Rotation drive
230 Annulus
400 Sample mount assembly
402 Sample mount
404 Opening
406 Support surface
408 Holding unit
410 Suction element
412 Edge
420 Recess
422 Suction line
424 Suction line
426 Vacuum pump
500 Sample mount assembly
502 Sample mount
504 Opening
506 Support surface
508 Holding unit
510 Suction element
512 Edge
520 Recess
522 Suction line
528 Recess
530 Annulus
600,600′ Sample mount assembly
602 Sample mount
604 Opening
606 Support surface
608,608′ Holding unit
610,610′ Suction element
612 Edge
630 Annulus
700 Sample mount assembly
702 Sample mount
704 Opening
706 Support surface
708 Holding unit
710 Suction element
712 Edge
720 Recess
732 Ring segment
734 Dividing bar
800 Sample mount assembly
802 Sample mount
804 Opening
806 Support surface
808 Holding unit
810 Nozzle
812 Edge
908 Holding unit
α Angle
β Angle
γ Angle
A Rotation axis
E Plane
F_{H}, F_{H}′ Force
F_{P} Force
F_{S} Force
R Edge region
Rz Direction
x, y, z Direction

What is claimed is:

1. A sample mount assembly, comprising:
a sample mount, comprising:
a support surface configured to support a sample, the support surface comprising an opening; and
a holding unit configured to hold the sample by exerting, adjacent an edge of the opening, a holding force on the sample toward the support surface.

2. The sample mount assembly of claim 1, further comprising a base supporting the sample mount rotatably around a rotation axis passing through the opening of the sample mount.

3. The sample mount assembly of claim 1, wherein:
the holding unit comprises multiple holding elements;
each holding element is configured to exert a holding force on the sample; and
the sample mount assembly is configured to control the multiple holding elements so that, when at least one holding element exerts a holding force on the sample, the other holding elements are idle.

4. The sample mount assembly of claim 1, wherein the holding unit comprises a suction element configured to exert a suction force on the sample.

5. The sample mount assembly of claim 4, wherein the suction element comprises:
a recess which is recessed from the support surface; and
a suction line fluidly connected to the recess to generate a negative pressure inside the recess.

6. The sample mount assembly of claim 4, wherein the suction element comprises multiple spaced apart suction elements along an annulus adjacent the edge of the opening.

7. The sample mount assembly of claim 6, wherein the suction element comprises multiple spaced apart suction elements evenly distributed along an annulus adjacent the edge of the opening.

8. The sample mount assembly of claim 4, wherein the suction element comprises a ring-shaped suction element adjacent the edge of the opening.

9. The sample mount assembly of claim 8, wherein the ring-shaped suction element comprises multiple ring segments, and the sample mount assembly is configured to control the multiple ring segments so that, when at least one ring segment exerts a suction force on the sample, the other multiple ring segments are idle.

10. The sample mount assembly of claim 1, wherein the holding unit comprises a compressed air nozzle facing the support surface to exert a pressing force on the sample.

11. The sample mount assembly of claim 1, further comprising a further holding unit configured to hold the sample by exerting a further holding force on an outer edge of the sample toward the support surface.

12. An x-ray imaging system, comprising:
a sample mount assembly according to claim 1.

13. The x-ray imaging system of claim 12, further comprising:
an x-ray source configured to emit x-rays toward a region of interest of the sample; and
an x-ray detector configured to detect x-rays transmitted through the region of interest.

14. The x-ray imaging system of claim 13, further comprising a relocation unit configured to: i) relocate the sample relative to the sample mount and ii) arrange the sample on the sample mount so that the region of interest of the sample is at the opening of the sample mount.

15. The x-ray imaging system of claim 14, wherein the x-ray imaging system is configured to: i) obtain two-dimensional transmission images of the region of interest of the sample for different rotation angles of the sample with respect to the rotation axis; and ii) reconstruct a three-dimensional image of the region of interest based on the two-dimensional transmission images.

16. The x-ray imaging system of claim 12, further comprising:
an x-ray source configured to emit x-rays toward a region of interest of the sample; and
an x-ray detector configured to detect x-rays transmitted through the region of interest.

17. The x-ray imaging system of claim 12, further comprising a relocation unit configured to: i) relocate the sample relative to the sample mount and ii) arrange the sample on the sample mount so that the region of interest of the sample is at the opening of the sample mount.

18. The x-ray imaging system of claim 12, wherein the x-ray imaging system is configured to: i) obtain two-dimensional transmission images of the region of interest of the sample for different rotation angles of the sample with respect to the rotation axis; and ii) reconstruct a three-dimensional image of the region of interest based on the two-dimensional transmission images.

19. A sample mount assembly, comprising:
a sample mount, comprising:
a support surface configured to support a sample, the support surface comprising an opening; and
a holding unit configured to exert on the sample toward the support surface to hold the sample.

20. The sample mount assembly of claim 19, further comprising a base supporting the sample mount rotatably around a rotation axis passing through the opening of the sample mount.
